(19) United States
(12) Patent Application Publication
(10) Pub. No.: US 2026/0172684 A1
(43) Pub. Date: Jun. 18, 2026

(54) CONTROL APPARATUS AND METHOD, IMAGE STABILIZATION APPARATUS, IMAGE CAPTURING APPARATUS, AND STORAGE MEDIUM

(71) Applicant: CANON KABUSHIKI KAISHA, Tokyo (JP)

(72) Inventors: YOHEI OHASHI, Chiba (JP); HIROMI KOTOKU, Tokyo (JP)

(21) Appl. No.: 19/412,454

(22) Filed: Dec. 8, 2025

(30) Foreign Application Priority Data
Dec. 16, 2024 (JP) 2024-220253

(51) Int. Cl. H04N 23/68; H04N 23/667; H04N 23/69

(52) U.S. Cl. CPC H04N 23/687; H04N 23/667; H04N 23/683; H04N 23/69; H04N 23/6812

(57) ABSTRACT

A control apparatus that controls an optical image stabilization unit and an electrical image stabilization unit, comprises: a first acquisition unit that acquires a shake amount representing a magnitude of shake; a second acquisition unit that acquires a tracking amount; a third acquisition unit that acquires a first ratio for allocating a movable area of the optical image stabilization unit to image stabilization and a second ratio to tracking control, and a third ratio for allocating a movable area of the partial image of the electrical image stabilization unit to the image stabilization and a fourth ratio to the tracking control; and a fourth acquisition unit that acquires control amounts of the first and second image stabilization unit for the image stabilization and the tracking control based on the shake amount, the tracking amount, and the first to fourth ratios.

### BACKGROUND

### Field of the Technology

The present disclosure relates to a control apparatus and method, image stabilization apparatus, image capturing apparatus, program and storage medium, and more particularly to a technology for image stabilization and subject tracking using an image stabilization function.

### Description of the Related Art

Conventionally, there are image capturing apparatuses with an image stabilization function that stabilizes camera shake when capturing moving images. Such image capturing apparatuses detect camera shake using, for example, an angular velocity sensor, and then actuate a correction lens or image sensor to counteract the detected camera shake, or perform image processing to crop a small area relative to the imaging area and geometrically deform the resulting image. Generally, the former is called optical image stabilization, and the latter is called electronic image stabilization.

Also known is a subject tracking technology that detects a subject from a captured image, tracks the detected subject using an image stabilization function, and keeps the subject at a predetermined position within an angle of view.

Japanese Patent Laid-Open No. 2017-215350 proposes a technique for determining whether to prioritize an image stabilization function or a subject tracking function when executing these functions so as to achieve both image stabilization performance and subject tracking performance using a correction lens.

However, in a case where subject tracking is performed using only either the optical image stabilization function or the electronic image stabilization function, there are limitations to the improvement of subject tracking performance. For example, if subject tracking is performed using only the electronic image stabilization function, problems are known, such as the need to increase the size of the image sensor to improve subject tracking performance, and the difficulty of improving subject tracking performance due to decrease in the correction angle as the focal length approaches the telephoto side. On the other hand, if subject tracking is performed using only the optical image stabilization function, the correction angle cannot be improved unless the movable area of the members used for the optical image stabilization (the correction lens and/or the image sensor) is widened. In addition, depending on how these members are moved, vibrations and operating noises may be generated, which may impair the quality in using the optical image stabilization function.

### SUMMARY

The present disclosure has been made in consideration of the above situation, and in subject tracking using both optical and electronic image stabilization functions, the tracking range is expanded while maintaining quality in using the image stabilization functions.

According to the present disclosure, provided is a control apparatus that controls a first image stabilization unit that performs optical image stabilization and a second image stabilization unit that performs image stabilization by changing a crop position of a partial image cropped from an image captured by an image sensor, the apparatus comprising one or more processors and/or circuitry which function as: a first acquisition unit that acquires a shake amount representing a magnitude of shake of a detection target; a second acquisition unit that acquires a tracking amount for keeping a predetermined subject included in the image at a predetermined position in the partial image; a third acquisition unit that acquires a first ratio for allocating a movable area of the first image stabilization unit to image stabilization and a second ratio for allocating the movable area of the first image stabilization unit to tracking control, a third ratio for allocating a movable area of the partial image of the second image stabilization unit to the image stabilization, and a fourth ratio for allocating the movable area of the partial image to the tracking control, according to a predetermined condition; and a fourth acquisition unit that acquires control amounts of the first image stabilization unit and control amounts of the second image stabilization unit for the image stabilization and the tracking control based on the shake amount, the tracking amount, and the first to fourth ratios.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram illustrating a configuration of an image capturing system according to an embodiment of the present disclosure.

FIG. 2 is a block diagram illustrating a configuration for performing image stabilization control and subject tracking control according to the embodiment.

FIG. 3 is a diagram illustrating a ratio table according to a first embodiment.

FIG. 4 is a flowchart illustrating image stabilization control and subject tracking control according to the first embodiment.

FIG. 5 is a diagram illustrating another ratio table according to the first embodiment.

FIG. 6 is a diagram illustrating yet another ratio table according to the first embodiment.

FIG. 7 is a diagram illustrating yet another ratio table according to the first embodiment.

FIG. 8AA and 8AB are graphs illustrating examples of transition in a tracking control amount according to a second embodiment.

FIG. 8BA and 8BB are graphs illustrating other examples of transitions in the tracking control amount according to the second embodiment.

FIG. 9 is a flowchart illustrating control according to the second embodiment.

FIGS. 10A and 10B are explanatory diagrams of an angle of view to explain a problem to be solved according to a third embodiment.

FIG. 11 is an explanatory diagram of an angle of view in a case where control is performed according to the third embodiment.

FIG. 12 is a graph illustrating an example of transitions in a tracking control amount according to the third embodiment.

FIG. 13 is a flowchart illustrating subject tracking control according to the third embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

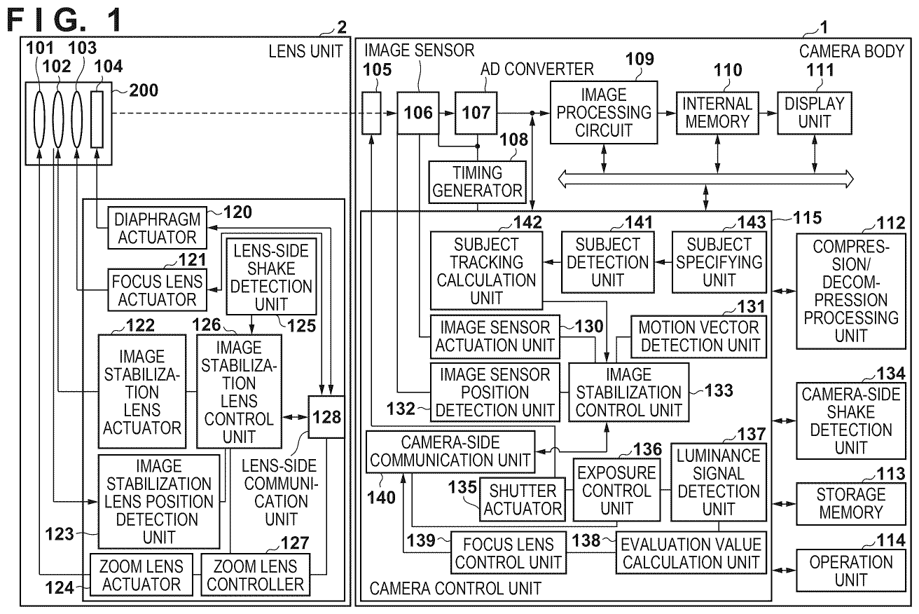

FIG. 1 is a block diagram illustrating a configuration of an image capturing system according to an embodiment of the present disclosure. The image capturing system in this embodiment mainly comprises a camera body 1 and a lens unit 2 that is detachable from the camera body 1. When the lens unit 2 is attached to the camera body 1, information is transmitted through a camera-side communication unit 140 and a lens-side communication unit 128.

First, the configuration of the lens unit 2 will be explained.

An imaging optical system 200 includes a zoom lens 101, an image stabilization lens 102, a focus lens 103, and a diaphragm 104. A zoom lens actuator 124 actuates the zoom lens 101 in the optical axis direction to optically change the focal length of the imaging optical system 200, thereby changing the angle of view. In addition, a zoom lens controller 127 controls the position of the zoom lens 101 by controlling the zoom lens actuator 124 in accordance with zoom instructions entered by a photographer operating an operation unit 114. A focus lens actuator 121 adjusts the in-focus position by moving the focus lens 103 in the optical axis direction. A diaphragm actuator 120 adjusts an amount of incident light by controlling the aperture diameter of the diaphragm 104.

An image stabilization lens position detection unit 123 detects the position of the image stabilization lens 102. A lens-side shake detection unit 125 detects shake or vibrations applied to the lens unit 2 (detection target) and outputs a shake detection signal. The lens-side shake detection unit 125 can be a device, such as a gyro sensor, that detects angular velocity or a device, such as an acceleration sensor, that detects acceleration. An image stabilization lens control unit 126 calculates an image stabilization amount to suppress shake based on the shake detection signal output from the lens-side shake detection unit 125, a camera-side shake detection unit 134, or both, and the current position of the image stabilization lens 102 detected by the image stabilization lens position detection unit 123, and notifies an image stabilization lens actuator 122 of the calculated image stabilization amount. The image stabilization lens actuator 122 optically corrects image blur caused by shake of the image capturing system by moving the image stabilization lens 102 in a direction perpendicular to the optical axis.

Next, the configuration of the camera body 1 will be explained.

Light that passes through the imaging optical system 200 is received by an image sensor 106, that may be a charge-coupled device (CCD), complementary metal-oxide semiconductor (CMOS) sensor, or the like, via a shutter 105, and undergoes photoelectric conversion from an optical signal to an electrical signal. The shutter 105 is actuated by a shutter actuator 135.

An AD converter 107 performs noise reduction processing, gain adjustment processing, and AD conversion processing on the analog image signal output from the image sensor 106, and outputs a digital image signal.

A timing generator 108 controls the actuation timing of the image sensor 106 and the processing timing of the AD converter 107 in accordance with instructions from a camera control unit 115.

An image processing circuit 109 performs pixel interpolation processing, color conversion processing, etc. on the digital image signal output from the AD converter 107, and then sends the processed image data to an internal memory 110. The image processing circuit 109 includes a circuit for aligning a plurality of images captured in succession, a geometric transformation circuit for performing cylindrical coordinate transformation and distortion correction corresponding to the lens group, a synthesis circuit for performing trimming and synthesis processing, and so on.

The image processing circuit 109 also performs electronic image stabilization and subject tracking by performing image processing of cropping a partial area from the captured image area and, upon cropping the partial area, controlling the crop position depending on the direction and magnitude of image blur. In this embodiment, the crop position is controlled based on a control amount for a crop position in an image calculated by a control amount calculation unit 1333 (described later). Note that the electronic image stabilization in this embodiment is performed using a projective transformation circuit provided in the image processing circuit 109.

A display unit 111 displays shooting information and the like along with the image data stored in the internal memory 110.

A compression/decompression processing unit 112 performs compression or decompression processing on the image data stored in the internal memory 110 according to an image format.

A storage memory 113 stores various data such as parameters.

The operation unit 114 is a user interface that allows a user to issue various commands to the image capturing system, such as various menu operations and mode switching operations.

The camera control unit 115 is composed of an arithmetic unit such as a central processing unit (CPU), and executes various control programs stored in the internal memory 110 in response to user operations via the operation unit 114. The control programs are programs for performing, for example, zoom control, image stabilization control, automatic exposure control, automatic focus adjustment control, processing for detecting the face of a subject, subject tracking control, and so forth.

A luminance signal detection unit 137 detects the luminance of the subject and the luminance of the scene from the image signal read out from the image sensor 106 and output from the AD converter 107. An exposure control unit 136 calculates the exposure value (aperture value and shutter speed) based on the luminance information obtained by the luminance signal detection unit 137, and notifies the shutter actuator 135 and the diaphragm actuator 120 via the camera-side communication unit 140 and the lens-side communication unit 128 of the calculation result. The exposure control unit 136 also simultaneously performs gain control in the image sensor 106 to amplify the signal to be read out, thereby performing automatic exposure control (AE control).

An evaluation value calculation unit 138 extracts specific frequency components from the luminance information obtained by the luminance signal detection unit 137, and calculates a contrast evaluation value based on the extraction result.

A focus lens control unit 139 issues a command to actuate the focus lens 103 by a predetermined actuation amount over a predetermined range. At the same time, the contrast evaluation value, which is the calculation result of the evaluation value calculation unit 138 for the luminance information of the image signal obtained at each focus lens position, is acquired. The defocus amount is calculated based on the focus lens position at which the curve of the contrast evaluation values obtained in this way reaches its peak, and is notified to the focus lens actuator 121 via the camera-side communication unit 140 and the lens-side communication unit 128. The focus lens actuator 121 then actuates the focus lens 103 in accordance with the defocus amount, thereby performing contrast-based automatic focusing control (AF control) so that the light flux converges on the surface of the image sensor 106.

Although focus adjustment control based on the contrast method has been described here, focus adjustment control based on the phase difference method may also be used. Focus adjustment control based on the phase difference method is well known, and therefore a description thereof will be omitted.

The camera-side shake detection unit 134 detects vibrations and shakes applied to the camera body 1 (detection target). As the camera-side shake detection unit 134, a device that detects angular velocity such as a gyro sensor or a device that detects acceleration such as an acceleration sensor may be used, but in this embodiment, it is assumed that the camera-side shake detection unit 134 detects angular velocity and outputs an angular velocity signal.

An image stabilization control unit 133 can communicate with the image stabilization lens control unit 126 via the camera-side communication unit 140 and the lens-side communication unit 128. The image stabilization control unit 133 calculates an image stabilization amount for suppressing image blur using the image sensor 106 based on shake detection signal detected by the camera-side shake detection unit 134, the lens-side shake detection unit 125, or both. Then, based on the calculated image stabilization amount and the current position of the image sensor 106 detected by an image sensor position detection unit 132, the image stabilization control unit 133 transmits an actuation signal to actuate the image sensor 106 to an image sensor actuation unit 130, thereby controlling image stabilization by the image sensor 106. Based on the actuation signal received from the image stabilization control unit 133, the image sensor actuation unit 130 actuates the image sensor 106 in a direction perpendicular to the optical axis.

A motion vector detection unit 131 uses a block matching method to calculate the correlation value between the image of the current frame and the image of the preceding frame for each block obtained by dividing each frame, then searches for the block of the preceding frame that has the smallest correlation value, and detects the deviation of other blocks relative to that block as a motion vector.

A subject specifying unit 143 sets one of the subjects in the captured image as a tracking target subject. The photographer can set any subject by touching or operating a button via the operation unit 114. Furthermore, if the photographer does not set the subject, the tracking target subject may be determined by an automatic subject setting program.

A subject detection unit 141 detects the area of the tracking target subject, set by the subject specifying unit 143, and generates subject detection information. The subject detection information includes information such as the type of subject (e.g., person, animal, vehicle), body part (e.g., pupil, face, body), position, and size.

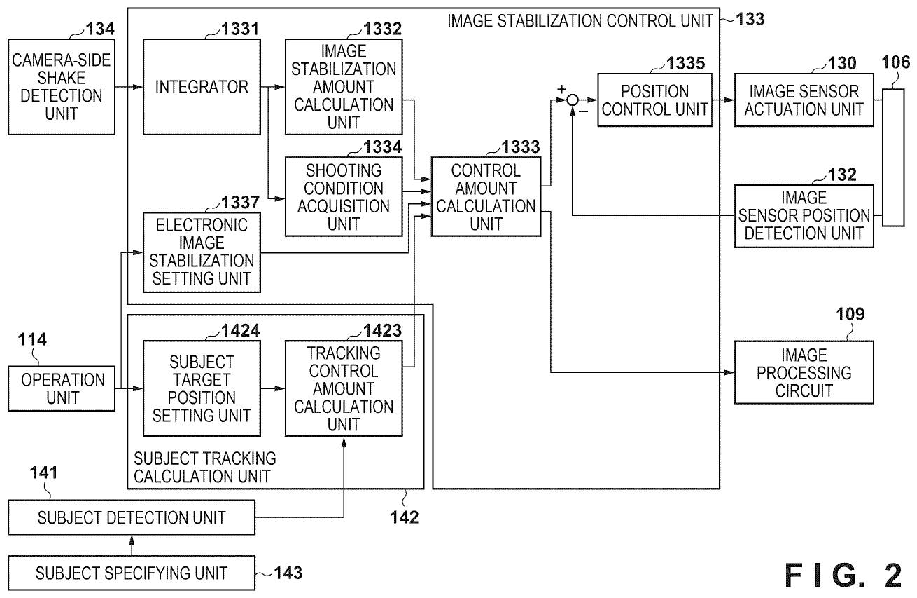

A subject tracking calculation unit 142 calculates a tracking amount for tracking the tracking target subject, based on the subject detection information. Details will be explained below using FIG. 2.

FIG. 2 is a block diagram illustrating a configuration for performing image stabilization control and subject tracking control in the first embodiment, and particularly shows the detailed configuration of the image stabilization control unit 133 and the subject tracking calculation unit 142. In this embodiment, image stabilization can be performed by optical image stabilization and electronic image stabilization, and further, the optical image stabilization includes a method for actuating the image stabilization lens 102 and a method for actuating the image sensor 106. In the following explanation, the optical image stabilization is described as being performed by actuating the image sensor 106, but it may also be performed by actuating the image stabilization lens 102 alone, or by actuating both the image stabilization lens 102 and the image sensor 106.

An integrator 1331 integrates and converts the angular velocity signal output from the camera-side shake detection unit 134 into a shake angle. For example, an integral low-pass filter (LPF) may be used for the integration processing. Note that if the camera-side shake detection unit 134 is an acceleration sensor, the integrator 1331 performs second-order integration to convert the output acceleration signal into a shake amount corresponding to the shake angle.

An image stabilization amount calculation unit 1332 calculates an image stabilization amount that cancels the shake angle by taking into consideration the frequency band of the shake angle obtained by the integrator 1331 and the range (movable area) in which the image sensor 106 can be actuated. Specifically, the image stabilization amount is calculated by multiplying the shake angle by gains related to the zoom magnification and the distance to the subject.

Based on the shake angle obtained by the integrator 1331, a shooting condition acquisition unit 1334 acquires the shooting condition including the vibration state, such as whether the camera is in a static state as being installed on a tripod or the like, whether the vibration caused by hand shake is large or small.

An electronic image stabilization setting unit 1337 receives user settings related to electronic image stabilization from the operation unit 114. Here, it is possible to select whether to perform the electronic image stabilization, the strength of the correction effect from a plurality of correction modes, whether to perform the subject tracking, etc., and the angle of view cropped from the imaging area is determined according to the settings.

A subject target position setting unit 1424 calculates and sets a subject target position, which is a position on the screen where the subject to be tracked will be captured when the subject tracking control is executed. The subject target position is changeable, and possible setting values include the center of the angle of view, a position on the screen touched by the photographer, a position corresponding to coordinates stored in advance, etc.

A tracking control amount calculation unit 1423 calculates a tracking control amount according to the subject target position set by the subject target position setting unit 1424 and the position of the subject included in the subject detection information from the subject detection unit 141.

The control amount calculation unit 1333 calculates the control amount of an optical image stabilization member (here, the image sensor 106) and the control amount of the crop position of the partial area for the electronic image stabilization, based on the image stabilization amount calculated by the image stabilization amount calculation unit 1332, the tracking control amount calculated by the tracking control amount calculation unit 1423, the shooting conditions acquired by the shooting condition acquisition unit 1334, and the settings related to the electronic image stabilization set by the electronic image stabilization setting unit 1337. In this embodiment, the control amount calculation unit 1333 calculates the control amount using a ratio table, which will be described later. The calculated control amount of the optical image stabilization member is output to a position control unit 1335, and the control amount of the crop position of the partial area is output to the image processing circuit 109.

The position control unit 1335 performs PID control (ratio control, integral control, and differential control) on the deviation between the target position of the image sensor 106 based on the control amount of the optical image stabilization member calculated by the control amount calculation unit 1333 and the current position detected by the image sensor position detection unit 132. The position control unit 1335 then converts the deviation into an actuation signal for the image sensor 106 and inputs it to the image sensor actuation unit 130, thereby controlling the position of the image sensor 106 to be at the target position, thereby achieving the optical image stabilization and the subject tracking. Note that PID control is a commonly used technique, so a detailed description thereof will be omitted.

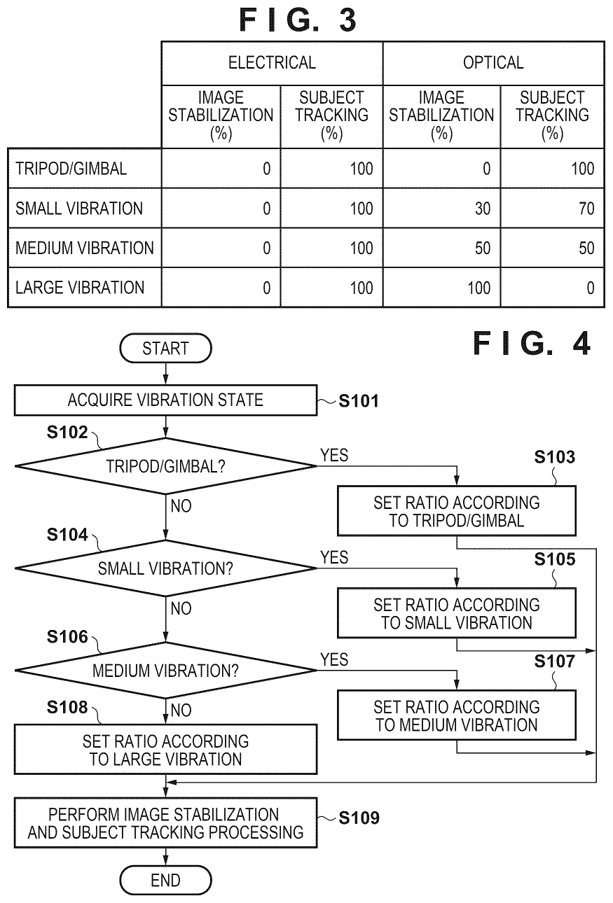

Next, a calculation method of the control amount in the control amount calculation unit 1333 will be explained with reference to FIG. 3.

FIG. 3 illustrates a ratio table showing the ratios at which the movable area of the partial area to be cropped in the electronic image stabilization and the movable area of the optical image stabilization member are allocated to image stabilization and subject tracking. The left column of FIG. 3 shows the vibration state (conditions) acquired by the shooting condition acquisition unit 1334. In this embodiment, the detected shake is classified into four levels: “tripod/gimbal,” “small vibration,” “medium vibration,” and “large vibration.” The values in the table in FIG. 3 also represent the image stabilization/tracking ratio of the movable area allocated to the image stabilization and the subject tracking, in a case where the movable area of the partial area to be cropped in the electronic image stabilization and the movable area of the optical image stabilization member are set to 100%, respectively. In this embodiment, the movable areas are set according to the magnitude of the shake.

Note that the values in the table in FIG. 3 indicate the extent to which the control image stabilization capability of each image stabilization is utilized, and do not mean, for example, that 30% of the image stabilization is to correct 30% of the camera shake component. Furthermore, in the electronic image stabilization, the higher the capability of image stabilization, the smaller the size of the cropped partial area. Therefore, the size of the cropped partial area is limited to prevent it from becoming too small. For example, 100% of the electronic image stabilization indicates the image stabilization capability in a case where the smallest partial area within the limited size is cropped.

For example, if the shooting conditions of a camera are determined to be “tripod/gimbal,” then 0% of both the electronic image stabilization and the optical image stabilization are allocated to the image stabilization, and 100% are allocated to the subject tracking, as shown in the table in FIG. 3. This indicates that camera shake will be very small and the image stabilization control will not be necessary, so the image stabilization is not performed and the entire movable areas are allocated to the subject tracking, and that this control state is to maximize the subject tracking performance.

Furthermore, if the shooting conditions of the camera are determined to be “small vibration,” 0% of the electronic image stabilization is allocated to the image stabilization and 100% to the subject tracking, while 30% of the optical image stabilization is allocated to the image stabilization and 70% to the subject tracking. This indicates that the camera is judged to be under slight vibration, so 30% of the movable area of the optical image stabilization is allocated to the image stabilization.

Similarly, in this embodiment, the allocation ratio of the optical image stabilization to the image stabilization is increased as the camera vibration condition is determined to be “medium vibration” and to be “large vibration,” and in the “large vibration” condition, the entire movable area (100%) of the optical image stabilization is allocated to image stabilization.

In this way, by allocating a larger proportion of the movable area to the subject tracking when vibration is small, and allocating a larger proportion of the movable area to the image stabilization as the vibration increases, it is possible to achieve a good balance between the subject tracking control and the image stabilization control depending on the vibration state.

Next, the image stabilization control and the subject tracking control in this embodiment will be described using the flowchart shown in FIG. 4.

In step S101, the camera control unit 115 acquires shooting conditions (vibration state) from the shooting condition acquisition unit 1334.

In step S102, if the vibration state acquired in step S101 indicates “tripod/gimbal,” the process proceeds to step S103, where 0% of the movable area of the electronic image stabilization is allocated to the image stabilization and 100% is allocated to the subject tracking according to the ratio table shown in FIG. 3. Further, 0% of the movable area of the optical image stabilization is allocated to the image stabilization and 100% is allocated to the subject tracking, and the process proceeds to step S109.

If the vibration state indicates “small vibration” in step S104, the process proceeds to step S105, where 0% of the movable area of the electronic image stabilization is allocated to the image stabilization and 100% is allocated to the subject tracking according to the ratio table shown in FIG. 3. Further, 30% of the movable area of the optical image stabilization is allocated to the image stabilization and 70% is allocated to the subject tracking, and the process proceeds to step S109.

If the vibration state indicates “medium vibration” in step S106, the process proceeds to step S107, where 0% of the movable area of the electronic image stabilization is allocated to the image stabilization and 100% is allocated to the subject tracking according to the ratio table shown in FIG. 3. Further, 50% of the movable area of the optical image stabilization is allocated to the image stabilization and 50% is allocated to the subject tracking, and the process proceeds to step S109.

If the vibration state does not indicate “medium vibration” (i.e., “large vibration”) in step S106, the process proceeds to step S108, where 0% of the movable area of the electronic image stabilization is allocated to the image stabilization and 100% is allocated to the subject tracking according to the ratio table shown in FIG. 3. Further, 100% of the movable area of the optical image stabilization is allocated to the image stabilization and 0% is allocated to the subject tracking, and the process proceeds to step S109.

In step S109, the image stabilization and the subject tracking processing are performed using the control amounts for the image stabilization and the subject tracking calculated by the control amount calculation unit 1333 within the movable area based on the ratio set in any one of steps S103, S105, S107, and S108. Specifically, the image stabilization and the subject tracking are performed by controlling the actuation of the image sensor 106 and the crop position of the partial area based on the control amounts calculated by the control amount calculation unit 1333. Note that in a case where the image stabilization lens 102 is also used, the ratio of the movable area of the image stabilization lens 102 is added to the ratio table shown in FIG. 3, and the control amount of the optical image stabilization member calculated by the control amount calculation unit 1333 is assigned to the image sensor 106 and the image stabilization lens 102. Furthermore, if only the image stabilization lens 102 is used for the optical image stabilization, the image stabilization lens 102 may be controlled and actuated instead of the image sensor 106 based on the control amount of the optical image stabilization member calculated by the control amount calculation unit 1333.

It should be noted that the ratio table shown in FIG. 3 as described above is an example and may be modified as appropriate. Other examples of the ratio table will be described below.

### Ratio Table Based on User Intention

The ratio table shown in FIG. 3 was described as determining the movable area based on the vibration state determined by the shooting condition acquisition unit 1334 based on the shake angle. However, the movable area may also be determined based on the mode selected by the user via the operation unit 114.

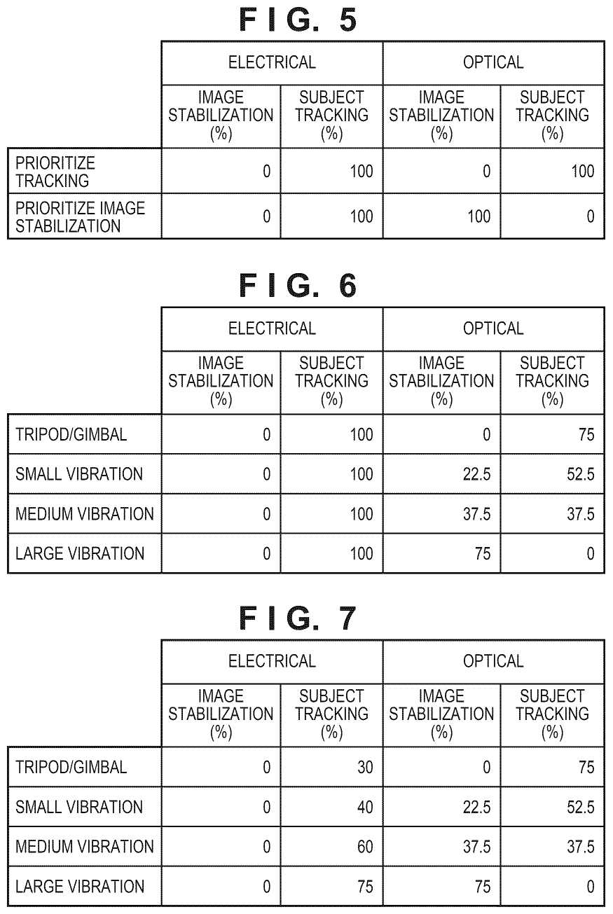

FIG. 5 shows an example of a ratio table in a case where the user can select “prioritize tracking” or “prioritize image stabilization” (conditions) through menu settings. As shown in FIG. 5, in a case where “prioritize tracking” is selected, 0% of both the electronic image stabilization and optical image stabilization is allocated to the image stabilization, and 100% of both the electronic image stabilization and optical image stabilization is allocated to the subject tracking. On the other hand, in a case where “prioritize image stabilization” is selected, 100% of the electronic image stabilization is allocated to the subject tracking, 0% of the electronic image stabilization is allocated to the image stabilization, 100% of the optical image stabilization is allocated to the image stabilization, and 0% of the optical image stabilization is allocated to the subject tracking. In this way, the ratio table may be set based on the user's settings, regardless of the shooting conditions.

Ratio Table with Restricted Optical Image Stabilization Area

In the ratio table shown in FIG. 3, the movable area of the optical image stabilization is allocated to the image stabilization and the subject tracking so that the allocated percentages total 100%. However, with lenses with significant distortion or lenses for which light incident at their periphery enters at a small incident angle, there are concerns about deterioration of image stabilization performance at the periphery, degradation of image quality due to decreased marginal illumination, and deterioration of autofocus performance. For example, if the optical image stabilization is used to continuously track a subject located at the periphery for an extended period of time, the degradation in image quality due to the aforesaid concerns may become significant. Therefore, in situations (conditions) where the above concerns exist, the movable area of the optical image stabilization may be limited.

FIG. 6 shows an example of a ratio table in a case where image height is limited. Compared to the ratio table shown in FIG. 3, the total percentage to be allocated to the image stabilization and the subject tracking is set to 75% instead of 100% to limit the movable area of the optical image stabilization, thereby preventing the degradation of each performance quality as described above.

### Ratio Table Prioritizing Image Quality

In the ratio table described in FIG. 3, the movable area of the electronic image stabilization is allocated to the image stabilization and the subject tracking so that the allocated percentages total 100%. However, in the electronic image stabilization, which crops an image corresponding to a partial area (hereinafter referred to as a partial image) from a captured image, the smaller the size of the cropped partial image, the smaller the angle of view, which results in degradation of image quality due to the subsequent enlargement process performed on the partial image. Therefore, an “image quality priority mode” (condition) may be used, and in a case where the user selects this mode, the movable area of the electronic image stabilization may be limited, imposing restrictions on the size of the cropped partial image, thereby improving image quality.

FIG. 7 shows an example of ratio table for the “image quality priority mode.” This ratio table is used instead of the ratio table shown in FIG. 3 in a case where the “image quality priority mode” is set. In contrast to the ratio table shown in FIG. 3, in the “image quality priority mode,” the sum of the percentages of the movable area of the electronic image stabilization allocated to the image stabilization and the subject tracking is limited to a smaller value depending on the vibration state, rather than being 100%. In this way, the size of the partial image can be increased by reducing the movable area of the electronic image stabilization.

For example, in a case of “tripod/gimbal,” the percentages of the movable area of the electronic image stabilization allocated to the image stabilization and the subject tracking are limited to a total of 30%. By limiting the total percentages in this way, it is possible to prevent the size of the partial image, i.e., the angle of view, from becoming too small. Meanwhile, in a case of “large vibration,” the percentages of the movable area of the electronic image stabilization are limited to a total of 75%. Compared to the case of “tripod/gimbal,” this limit is closer to the crop amount in a case where “image quality priority mode” is not selected, so as to balance the image stabilization and subject tracking performance. In this way, limiting the movable area of the electronic image stabilization according to the need for the image stabilization and the subject tracking can reduce image quality degradation associated with image cropping.

As described above, according to the first embodiment, the optical image stabilization and the electronic image stabilization can be effectively mixed depending on the vibration state of the image capturing system and the user's settings, allowing for a good balance between the image stabilization and the subject tracking.

### Modification

There are cases where the angle of view fluctuates significantly when shooting conditions change. For example, if a camera mounted on a tripod is removed from the tripod and lifted up, the control switches from “tripod/gimbal” to “small vibration” shown in the ratio table shown in FIG. 3. In this case, a ratio of the movable area of the optical image stabilization allocated to the subject tracking suddenly change from 100% to 70%, causing the angle of view to change dramatically.

When the shooting conditions change as described above, the user may be notified of the change in the angle of view by displaying a warning that a change in the angle of view may occur on the display unit 111. Alternatively, in a case where the subject tracking is prioritized as in the case of “prioritize tracking” as shown in FIG. 5, the angle of view may be maintained by not changing the movable area of the optical image stabilization allocated to the subject tracking, which is realized by keeping the movable area allocated before the shooting conditions change even after the shooting conditions change.

### Second Embodiment

Next, a second embodiment of the present disclosure will be described.

One issue that arises when using the optical image stabilization in addition to the electronic image stabilization for the subject tracking is the noise and vibration that may occur when the optical image stabilization member is moved abruptly. In this embodiment, as an example of a case where abrupt movement of the optical image stabilization member is required, the centering operation of the control amount when transitioning from a state in which the subject tracking is performed using the image stabilization function (hereinafter referred to as “subject tracking mode”) to normal image stabilization that does not perform the subject tracking (hereinafter referred to as “normal image stabilization mode”) will be described. Note that the configuration of the image capturing system in the second embodiment is the same as that described with reference to FIGS. 1 and 2, so a detailed description will be omitted here.

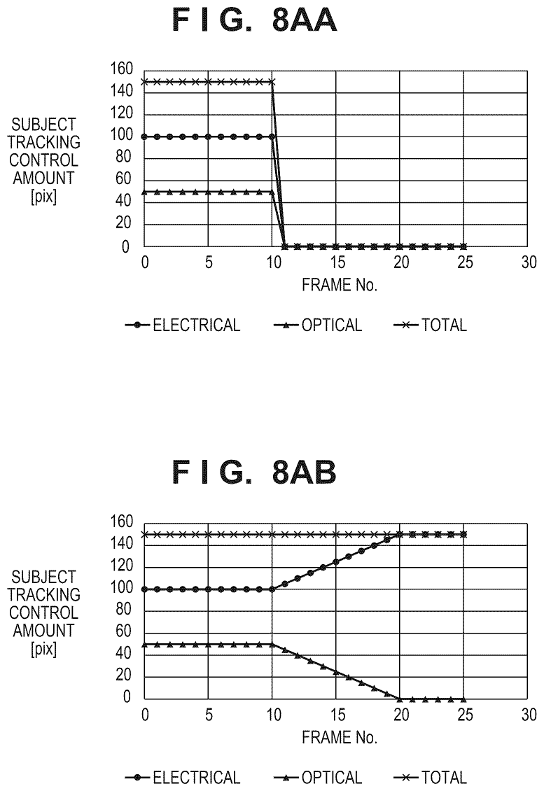

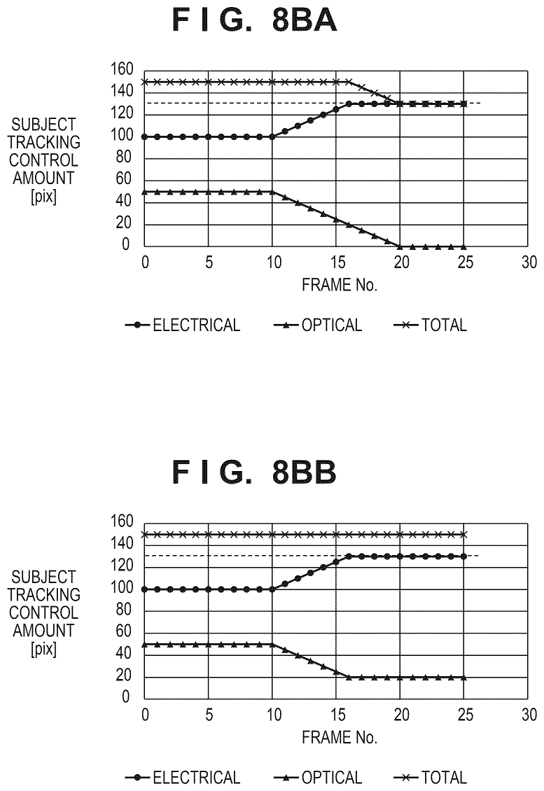

FIG. 8AA is a schematic graph illustrating the tracking control amount for the electronic image stabilization, the tracking control amount for the optical image stabilization, and the total tracking control amount over time in a case where transition from the subject tracking mode to the normal image stabilization mode occurs. Here, the vertical axis represents the number of pixels (pix) as the control amount, and the horizontal axis represents the frame number of an image as a change over time. The 0^{th} frame to the 10^{th} frame in FIG. 8AA are in the subject tracking mode, and show how the subject tracking is performed so as to make the total tracking control amount be 150 (pix).

In FIG. 8AA, when the setting is changed from the subject tracking mode to the normal image stabilization mode, control is performed to return the tracking control amount to 0 (pix) in the 11^{th} frame. In other words, by shifting the position of the optical image stabilization member and the crop position of the partial image in the electronic image stabilization to the center position, the maximum movable area is secured for the image stabilization from the 11^{th} frame onwards.

If the mode change involves a change in the crop area of a partial image in the electronic image stabilization, the image displayed in the screen is suddenly different after the mode change. In this case, the tracking control amount may be instantly returned to 0 (pixels), resulting in a natural transition in the appearance of the screen. However, as shown in FIG. 8AA, the optical image stabilization member (i.e., the image stabilization lens 102 or the image sensor 106) will be moved in a step-like, abrupt manner, generating operating noise and vibrations, which may impair the user's operational feel.

Accordingly, in the second embodiment, as shown in FIG. 8AB, the optical image stabilization member and the crop position of a partial image of the electronic image stabilization are gradually shifted in opposite directions over several frames. That is, when the subject tracking mode is switched to the normal image stabilization mode in the 10^{th} frame, the tracking control amount of the optical image stabilization member is gradually shifted to 0 (pix) over several frames, while the crop position of the partial image in the electronic image stabilization is shifted in the opposite direction to that of the optical image stabilization member. Here, the optical image stabilization member can be moved regardless of the frame cycle, but if the optical image stabilization member is not moved in synchronization with the transition of the crop position of the partial image in the electronic image stabilization, unnecessary fluctuations in the angle of view may occur. Therefore, until the transition is complete, the optical image stabilization member is controlled to be moved in synchronization with the timing at which frame is updated, which is the same timing when the crop position is shifted in the electronic image stabilization.

As described above, according to the second embodiment, by using the electronic image stabilization to cancel out the movement of the optical image stabilization member, it is possible to change modes without changing the total tracking control amount as well as the angle of view. Furthermore, by avoiding abrupt movement of the optical image stabilization member, it is possible to suppress noise and vibrations caused by the movement of the optical image stabilization member.

Note that the electronic image stabilization controls the cropping of a partial image from a captured image, so there is a limit in the control amount. Therefore, there is a possibility that the correction limit will be reached during the control shown in FIG. 8AB. FIG. 8BA is a graph showing such an example. The dashed line represents the limit value of the control amount for the electronic image stabilization, and the control amount for the electronic image stabilization reaches its limit in the 16^{th} frame. Meanwhile, because the control amount for the optical image stabilization member continues changing to 0, the total tracking amount changes from the 16^{th} frame to the 20^{th} frame. This may appear as a change in the angle of view due to the mode change causing discomfort to the user.

If the angle of view fluctuation is unacceptably large after the electronic image stabilization reaches its correction limit as described above, the following correction may be performed. That is, in the example of FIG. 8BA, display control may be performed such that a black image is displayed from the 16^{th} frame to the 20^{th} frame so as not to display captured images while the angle of view fluctuates. Alternatively, as shown in FIG. 8BB, when the electronic image stabilization reaches its limit, the process of moving the optical image stabilization member to the 0 (pix) position may be stopped. This may reduce the discomfort experienced by the user due to angle of view fluctuation during the state transitions, even when the electronic image stabilization reaches its limit.

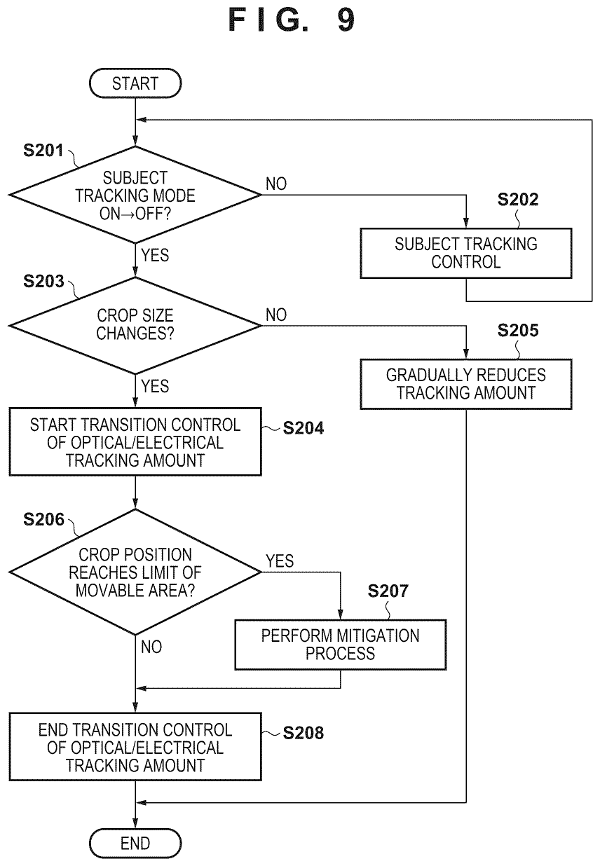

FIG. 9 is a flowchart illustrating control in the second embodiment.

In step S201, the electronic image stabilization setting unit 1337 detects whether the subject tracking mode is changed from ON to OFF by an operation on the operation unit 114. If the change is not detected, the control amount calculation unit 1333 continues subject tracking control in step S202 and repeats the determination in step S201.

If a change in the subject tracking mode from ON to OFF is detected in step S201, the electronic image stabilization setting unit 1337 determines in step S203 whether or not the crop size of the partial image will change in association with the mode change. If it is determined that the crop size of the angle of view will not change, there is no need to instantly cancel tracking, so in step S205 the control amount calculation unit 1333 performs control to gradually change the tracking amount to 0 over several frames, and the mode change ends.

If it is determined in step S203 that the crop size of the field of view will change, then in step S204, the control amount calculation unit 1333 starts control of changing the position of the optical image stabilization member and the crop position of the partial image in the electronic image stabilization based on the ratio shown in FIG. 8AB. That is, the control amount calculation unit 1333 starts changing processing that gradually changes the tracking amount by the optical image stabilization to 0 and changes the tracking amount by the electronic image stabilization in the opposite direction.

Next, in step S206, the control amount calculation unit 1333 determines, based on the current position of the optical image stabilization member and the current crop position of the partial image in the electronic image stabilization, whether the crop position will reach the limit of the movable area before the tracking amount of the optical image stabilization member becomes 0. If it is determined that the limit will not be reached, the changing process continues at the ratio shown in FIG. 8AB, and ends in step S208.

On the other hand, if it is determined in step S206 that the limit of the movable area will be reached, control is performed to mitigate the angle of view fluctuation that occurs when the limit is reached. Note that the control to mitigate the angle of view fluctuation may be, for example, as described in FIG. 8BB, control in which the control amount calculation unit 1333 stops moving the optical image stabilization member at the same time as the crop position of the partial image in the electronic image stabilization reaches the limit of the movable area. Alternatively, control may be performed to display a black image (stop display) on the display screen for the period from when the crop position of the partial image in the electronic image stabilization reaches the limit of the movable area to when the shift of the optical image stabilization member ends, or the changing processing described in FIG. 8AB may remain as is if the amount of angle of view fluctuation that occurs is within an allowable range.

As described above, according to the second embodiment, it is possible to reduce the operating noise and vibrations that occur when the optical image stabilization member is moved abruptly during a mode change from subject tracking mode, while also avoiding unnatural fluctuations in the display angle of view.

### Third Embodiment

Next, a third embodiment of the present disclosure will be described.

In the third embodiment, the explanation is given of the issues that arise in a case where the subject tracking mode is switched to a still image shooting mode and an example of the control in that case. Note that the configuration of the image capturing system described with reference to FIGS. 1 and 2 can be used in the third embodiment, so the description thereof will be omitted here.

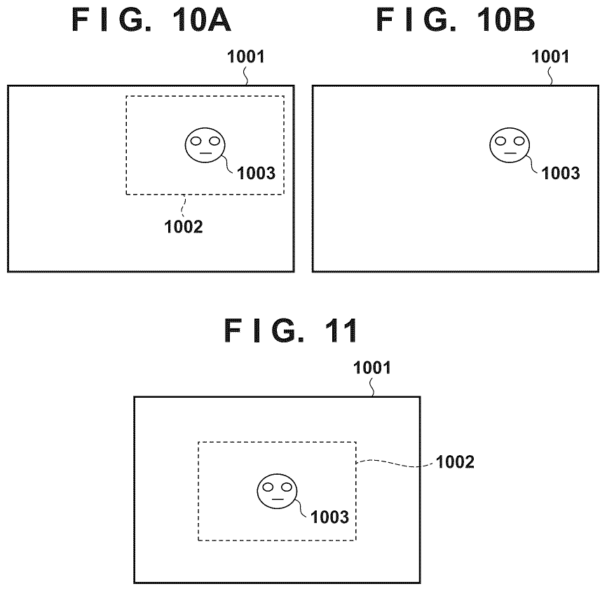

FIG. 10A shows the positional relationship between an angle of view 1001 of the image sensor 106 during tracking a subject 1003 in the subject tracking mode, a partial image 1002 cropped in the electronic image stabilization, and the subject 1003 being tracked. As a result of tracking the subject 1003 using the optical image stabilization and the electronic image stabilization, the captured image during tracking, i.e., the partial image 1002 indicated by the dashed line, is moved, and the subject 1003 being tracked is kept at the center of the partial image 1002.

FIG. 10B shows an angle of view in a case where the tracking state shown in FIG. 10A is switched to the still image shooting mode. In still image capture, a full-angle image captured by the image sensor is typically displayed and recorded, so cropping and enlargement of the partial image in the electronic image stabilization, as in video mode, is not performed. Therefore, as shown in FIG. 10B, the subject may be off-centered in the captured image, resulting in a composition that is contrary to the user's intention to keep the subject 1003 at the center.

Therefore, in this embodiment, when changing from the subject tracking mode to the still image shooting mode, the tracking control amount is changed as shown in FIG. 11.

FIG. 11 shows how the angle of view is corrected in a case where the subject tracking mode shown in FIG. 10A is switched to the still image shooting mode. That is, the tracking control amount in the electronic image stabilization is gradually transitioned to 0 (pix) (the center of the image sensor), and the optical image stabilization member is transitioned in the opposite direction to the tracking control amount for the electronic image stabilization to prevent the angle of view from changing. This makes it possible to maintain the position of the subject 1003 at the same position as during the subject tracking mode (the center of crop area 1102 of the partial image in the example of FIG. 11), even when still image capture is performed without the electronic image stabilization. Then, when still image capture is instructed in this state, an image of the entire angle of view 1001 of the image sensor 106 is recorded.

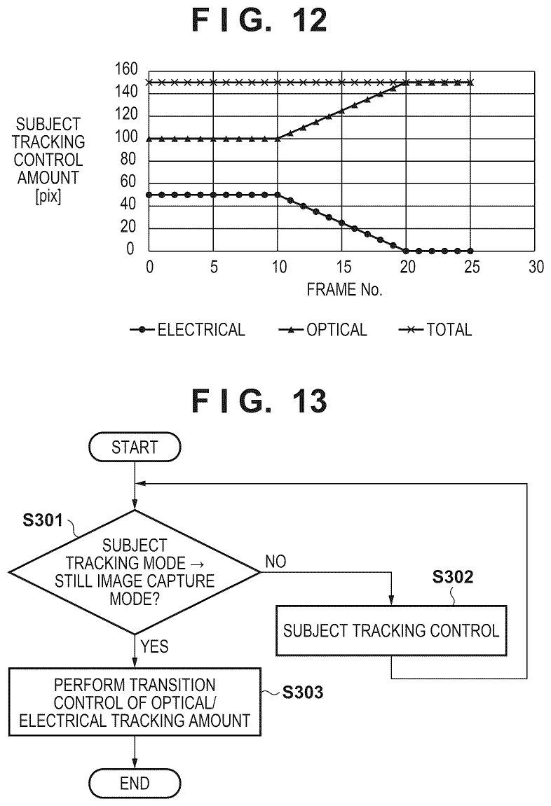

FIG. 12 illustrates an example of the transition of the tracking control amount when switching to the still image shooting mode. Similar to FIG. 8AA, 8AB, 8BA, and 8BB, FIG. 12 is a schematic graph illustrating the change in the tracking control amounts for the electronic image stabilization and the optical image stabilization, and the total tracking control amount over time. The 0^{th} frame to the 10^{th} frame are in the subject tracking mode, and show a state in which tracking correction of a tracking control amount 150 (pix) is performed using a combination of the optical image stabilization and the electronic image stabilization.

In FIG. 12, when the mode is changed from the subject tracking mode to the still image shooting mode in the 10^{th} frame, the tracking control amount for the electronic image stabilization is controlled to gradually change to 0 (pix), and the optical image stabilization member is controlled to move in the opposite direction to the tracking control amount for the electronic image stabilization. As shown in FIG. 12, the total tracking control amount does not change before and after the mode change, and the tracking control amount of the electronic image stabilization changes to 0 (pix), so the subject position can be maintained at the same position as during tracking control. Furthermore, by gradually moving the position of the optical image stabilization member over several frames, abrupt movement of the optical image stabilization member can be prevented, reducing the generation of operating noise and vibration.

Here, as described above, it is desirable that the control cycle of the optical image stabilization may be the same as the frame cycle and be synchronized with the control cycle of the electronic image stabilization until the transition to the still image shooting mode is complete. However, after the transition to the still image shooting mode is complete, the control cycle of the optical image stabilization may be changed to a faster cycle, such as the detection cycle of the camera-side shake detection unit 134, in order to maximize the effectiveness of image stabilization.

FIG. 13 is a flowchart showing control in the third embodiment.

In step S301, the control amount calculation unit 1333 obtains from the operation unit 114 whether or not the subject tracking mode is changed to the still image shooting mode. If no change is detected, in step S302, the control amount calculation unit 1333 generates a tracking control amount to continue the subject tracking control, and repeats the determination in step S301.

If a change to the still image shooting mode is detected in step S301, in step S303, the control amount calculation unit 1333 performs the tracking control amount transition process described with reference to FIG. 12. That is, the tracking control amount for the electronic image stabilization is gradually changed to 0 (pix) and the optical image stabilization member is moved in the direction opposite to the moving direction of the crop position by the tracking control amount for the electronic image stabilization, thereby transitioning to the still image shooting mode.

As described above, according to the third embodiment, in a case where the subject tracking mode is changed to the still image shooting mode, it is possible to capture a still image while tracking the subject at the intended angle of view and reducing the operating noise and vibrations that occur when the optical image stabilization member is moved.

### Other Embodiments

This disclosure may be applied to a system consisting of a plurality of devices, or to an apparatus consisting of a single device.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-220253, filed Dec. 16, 2024 which is hereby incorporated by reference herein in its entirety.

What is claimed is:

1. A control apparatus that controls a first image stabilization unit that performs optical image stabilization and a second image stabilization unit that performs image stabilization by changing a crop position of a partial image cropped from an image captured by an image sensor, the apparatus comprising one or more processors and/or circuitry which function as:
a first acquisition unit that acquires a shake amount representing a magnitude of shake of a detection target;
a second acquisition unit that acquires a tracking amount for keeping a predetermined subject included in the image at a predetermined position in the partial image;
a third acquisition unit that acquires a first ratio for allocating a movable area of the first image stabilization unit to image stabilization and a second ratio for allocating the movable area of the first image stabilization unit to tracking control, a third ratio for allocating a movable area of the partial image of the second image stabilization unit to the image stabilization, and a fourth ratio for allocating the movable area of the partial image to the tracking control, according to a predetermined condition; and
a fourth acquisition unit that acquires control amounts of the first image stabilization unit and control amounts of the second image stabilization unit for the image stabilization and the tracking control based on the shake amount, the tracking amount, and the first to fourth ratios.

2. The control apparatus according to claim 1 further comprising
a determination unit that determines a state of shake based on the shake amount,
wherein the predetermined condition is the state of the shake, and the greater the state of the shake, the higher the first ratio is and the lower the second ratio is.

3. The control apparatus according to claim 2, wherein the predetermined condition is quality of the image at a peripheral image height of the image sensor, and
the movable area of the first image stabilization unit becomes smaller in a case where the quality of the image at the peripheral image height deteriorates than in a case where the image quality does not deteriorate.

4. The control apparatus according to claim 3 further comprising a fifth acquisition unit that acquires information about an optical system that causes light to be incident on the image sensor,
wherein the image quality at the peripheral image height deteriorates in a case where the optical system includes at least one of a lens with large distortion and a lens on which light incident at its periphery at small incident angle.

5. The control apparatus according to claim 2 further comprising a detection unit that detects whether an image quality priority mode that prioritizes image quality is selected by an operation unit,
wherein the movable area of the first image stabilization unit is narrower in a case where the image quality priority mode is selected than in a case where the image quality priority mode is not selected.

6. The control apparatus according to claim 1 further comprising a detection unit that detects whether a first priority mode that prioritizes reduction of the shake amount or a second priority mode that prioritizes tracking of the subject is selected by an operation unit;
wherein the first ratio is higher in a case where the first priority mode is selected than in a case where the second priority mode is selected, and
the second ratio is higher in a case where the second priority mode is selected than in a case where the first priority mode is selected.

7. The control apparatus according to claim 6 further comprising:
a determination unit that determines a state of shake based on the shake amount; and
a display control unit that displays the partial image cropped by the second image stabilization unit on a display unit,
wherein the display control unit controls the display unit to display a warning in a case where the state of the shake determined by the determination unit changes.

8. The control apparatus according to claim 6 further comprising a determination unit that determines a state of shake based on the shake amount,
wherein, in a case where the second priority mode is selected, the first to fourth ratios acquired by the third acquisition unit are maintained even if the state of the shake determined by the determination unit changes.

9. The control apparatus according to claim 1 further comprising a detection unit that detects ON/OFF of a tracking mode for tracking a subject set by an operation unit,
wherein in a case where the tracking mode is switched from ON to OFF, the fourth acquisition unit calculates a control amount for gradually moving the first image stabilization unit in a direction toward a position where the tracking amount becomes 0, and a control amount for the second image stabilization unit for cropping the partial image so as to cancel out a change in an angle of view caused by moving the first image stabilization unit.

10. The control apparatus according to claim 9, wherein in a case where the crop position of the partial image by the second image stabilization unit reaches a limit of the movable area, the fourth acquisition unit determines a control amount for the second image stabilization unit to stop moving the crop position and a control amount for the first image stabilization unit to stop moving in the direction toward the position where the tracking amount becomes 0.

11. The control apparatus according to claim 9 further comprising a display control unit that displays the partial image cropped by the second image stabilization unit on a display unit,
wherein in a case where the crop position of the partial image by the second image stabilization unit reaches a limit of the movable area, the display control unit stops displaying the partial image until the first image stabilization unit is moved to the position where the tracking amount becomes 0.

12. The control apparatus according to claim 1 further comprising a detection unit that detects a mode set by an operation unit,
wherein in a case where the mode is switched from a tracking mode for tracking the subject to a still image capture mode for shooting a still image, the fourth acquisition unit calculates a control amount for the second image stabilization unit for gradually moving the crop position of the partial image in a direction toward a position where the tracking amount becomes 0, and a control amount for moving the first image stabilization unit so as to cancel out a change in an angle of view caused by the second image stabilization unit.

13. The control apparatus according to claim 1, wherein
the first image stabilization unit is at least one of a correction unit that reduces image blur by moving a correction lens included in an imaging optical system in a direction perpendicular to an optical axis, and a correction unit that reduces image blur by moving, in a direction perpendicular to the optical axis, an image sensor that photoelectrically converts light incident through the imaging optical system and outputs an image signal, and
the fourth acquisition unit acquires, as the control amounts for the first image stabilization unit, control amounts for moving at least one of the correction lens and the image sensor in a direction perpendicular to the optical axis of the imaging optical system.

14. The control apparatus according to claim 1, wherein the first acquisition unit acquires at least one of a shake amount detected by a shake detection unit and a motion vector detected from images output from the image sensor.

15. A control apparatus that controls a first image stabilization unit that performs optical image stabilization and a second image stabilization unit that performs image stabilization by changing a crop position of a partial image cropped from an image captured by an image sensor, the apparatus comprising one or more processors and/or circuitry which function as:
a first acquisition unit that acquires a shake amount representing a magnitude of shake of a detection target;
a second acquisition unit that acquires a tracking amount for keeping a predetermined subject included in the image at a predetermined position in the partial image;
a third acquisition unit that acquires a first value indicating a degree of allocating the first image stabilization unit to image stabilization and a second value indicating a degree of allocating the first image stabilization unit to tracking control, a third value indicating a degree of allocating the second image stabilization unit to the image stabilization, and a fourth value indicating a degree of allocating the second image stabilization unit to the tracking control; and
a fourth acquisition unit that acquires control amounts of the first image stabilization unit and control amounts of the second image stabilization unit for the image stabilization and the tracking control based on the shake amount, the tracking amount, and the first to fourth values.

16. A control method for controlling a first image stabilization unit that performs optical image stabilization and a second image stabilization unit that performs image stabilization by changing a crop position of a partial image cropped from an image captured by an image sensor, the method comprising:
a first acquisition step of acquiring a shake amount representing a magnitude of shake of a detection target;
a second acquisition step of acquiring a tracking amount for keeping a predetermined subject included in the image at a predetermined position in the partial image;
a third acquisition step of acquiring a first ratio for allocating a movable area of the first image stabilization unit to image stabilization and a second ratio for allocating the movable area of the first image stabilization unit to tracking control, a third ratio for allocating a movable area of the partial image of the second image stabilization unit to the image stabilization, and a fourth ratio for allocating the movable area of the partial image to the tracking control; and
a fourth acquisition step of acquiring control amounts of the first image stabilization unit and control amounts of the second image stabilization unit for the image stabilization and the tracking control based on the shake amount, the tracking amount, and the first to fourth ratios.

17. An image stabilization apparatus comprising:
the control apparatus according to claim 15;
the first image stabilization unit;
the second image stabilization unit;
a first actuation unit that actuates the first image stabilization unit based on the control amounts of the first image stabilization unit acquired by the fourth acquisition unit; and
a second actuation unit that actuates the second image stabilization unit based on the control amounts of the second image stabilization unit acquired by the fourth acquisition unit.

18. An image capturing apparatus comprising:
the image stabilization apparatus according to claim 17; and
the image sensor.

19. A non-transitory computer-readable storage medium, the storage medium storing a program that is executable by the computer, wherein the program includes program code for causing the computer to function as a control apparatus that controls a first image stabilization unit that performs optical image stabilization and a second image stabilization unit that performs image stabilization by changing a crop position of a partial image cropped from an image captured by an image sensor, the apparatus comprising:
a first acquisition unit that acquires a shake amount representing a magnitude of shake of a detection target;
a second acquisition unit that acquires a tracking amount for keeping a predetermined subject included in the image at a predetermined position in the partial image;
a third acquisition unit that acquires a first ratio for allocating a movable area of the first image stabilization unit to image stabilization and a second ratio for allocating the movable area of the first image stabilization unit to tracking control, a third ratio for allocating a movable area of the partial image of the second image stabilization unit to the image stabilization, and a fourth ratio for allocating the movable area of the partial image to the tracking control; and
a fourth acquisition unit that acquires control amounts of the first image stabilization unit and control amounts of the second image stabilization unit for the image stabilization and the tracking control based on the shake amount, the tracking amount, and the first to fourth ratios.
